(19) United States
(12) Patent Application Publication
(10) Pub. No.: US 2018/0109462 A1
(43) Pub. Date: Apr. 19, 2018

(54) METHOD FOR OPTIMIZING STREAMING MEDIA TRANSMISSION AND CACHE APPARATUS USING THE SAME

(71) Applicants: NANNING FUGUI PRECISION INDUSTRIAL CO., LTD., Nanning (CN); HON HAI PRECISION INDUSTRY CO., LTD., New Taipei (TW)

(72) Inventor: YU-CHUNG LIN, New Taipei (TW)

(21) Appl. No.: 15/293,287

(22) Filed: Oct. 14, 2016

(51) Int. Cl. H04L 12/857; H04L 29/08; H04L 12/801; H04L 12/24

(52) U.S. Cl. CPC H04L 47/2491; H04L 67/2847; H04L 41/509; H04L 47/29; H04L 67/322

(57) ABSTRACT

A method for optimizing streaming media transmission which can be implemented in a cache apparatus whereby higher-resolution blocks of data can be procured for client viewing notwithstanding heavy data traffic or other intermittent obstacles. If the client requests a higher resolution of streaming media, the cache apparatus determines whether the request of the client is supported by network conditions between the cache apparatus and a content source. If not, the cache apparatus limits data transmission speed from the cache apparatus to the client and continues to provide the client with a lower resolution video data block in the meantime.

### FIELD

The subject matter herein generally relates to data transmission of streaming media.

### BACKGROUND

Digital streaming is available in digital communication networks, for example, the Internet. Streaming media players receive streaming content and render the same on the display of a client. The streaming media players monitor client conditions and adjust the streaming content accordingly. At intervals, the streaming media players determine how to adjust the streaming content appropriate for current conditions, and request higher or lower resolution accordingly of the streaming media.

The streaming media players run in the client and fetch the streaming content from a content source via a cache apparatus. The cache apparatus pre-fetches the streaming content from the content source and provides the pre-fetched streaming content to the client, in response to the requests of the streaming media players. If both the client's processor and network bandwidth between the client and the cache apparatus are operating below capacity, the streaming media players may request a higher resolution of stream which is not supported by weak network status between the cache apparatus and the content source. This leads streaming video rendered in the client to be switched back and forth between the high resolution and low resolution, and results in a non-fluent viewing experience.

### BRIEF DESCRIPTION OF THE DRAWINGS

Implementations of the present technology will now be described, by way of example only, with reference to the attached fingers, wherein:

FIG. 1 illustrates a schematic diagram of one embodiment of an operating environment of a cache apparatus in accordance with the present disclosure;

FIG. 2 illustrates a block diagram of one embodiment of functional modules of a cache apparatus in accordance with the present disclosure;

FIG. 3 illustrates a flowchart of one embodiment of a method for optimizing streaming media transmission; and

FIG. 4 illustrates a flowchart of another embodiment of a method for optimizing streaming media transmission.

### DETAILED DESCRIPTION

It will be appreciated that for simplicity and clarity of illustration, where appropriate, reference numerals have been repeated among the different fingers to indicate corresponding or analogous elements. In addition, numerous specific details are set fourth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

It should be noted that references to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

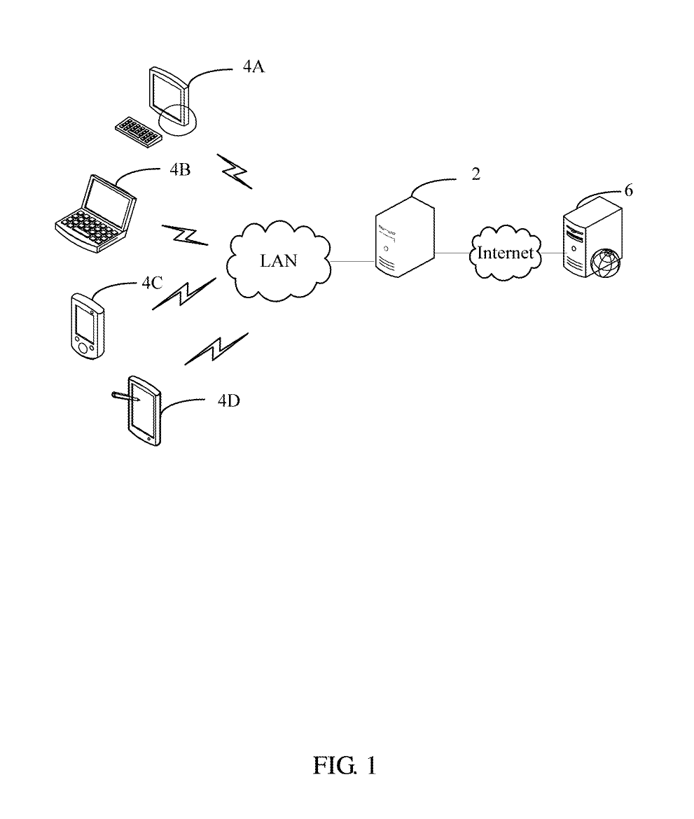

FIG. 1 illustrates one embodiment of an operating environment of one embodiment of a cache apparatus 2. The cache apparatus 2 connects with clients (e.g., clients 4A-4D) via a first network such as, for example, Local Area Network. The cache apparatus 2 connects with content source 6 via a second network such as, for example, Wide Area Network, Internet.

Embodiments of the clients 4A -4D may be include laptop computers, smart mobile phones, tablet personal computers, set top box, or the like. Based on adaptive bit-rate streaming technology, the clients 4A-4D may automatically adjust resolution of one or more streams appropriate for current network status.

When a client (e.g., client 4A) requests a streaming media file (e.g., “sample”) from the content source 6, the content source 6 feeds back a list (e.g., sample.m3u8) to the client 4A, wherein the “sample.m3u8” lists types of resolutions of the “sample” file which can be provided by the source content 6. The client 4A selects a type of resolution of the “sample” file (e.g., a first-resolution) according to settings or network status, and begins to request first-resolution video data blocks of “sample” file from the content source 6 via the cache apparatus 2.

The “sample” file includes a plurality of video data blocks (i.e., video segments), and each video data block includes several resolutions, for example, a first-resolution, a second-resolution, and more. In the embodiment, the second-resolution has more data than the first-resolution. A first-resolution 1-th video data block is represented with A₁, a first-resolution 2-th video data block is represented with A₂, a first-resolution 3-th video data block is represented with A₃, and so on. A second-resolution 1-th video data block is represented with B₁, a second-resolution 2-th video data block is represented with B₂, a second-resolution 3-th video data block is represented with B₃, and so on.

The client 4A fetches desired video data blocks from the content source 6 via the cache apparatus 2.

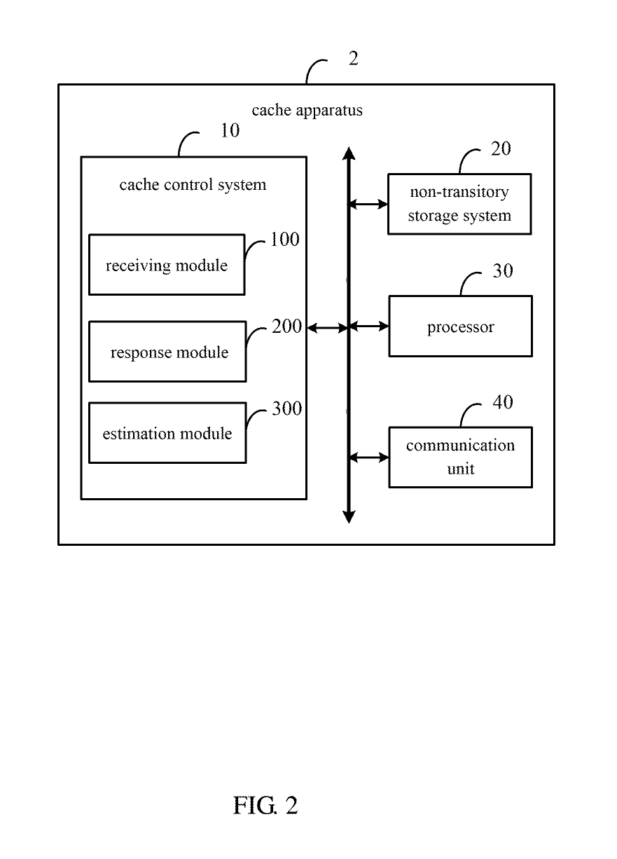

FIG. 2 illustrates one embodiment of functional modules of the cache apparatus 2. The cache apparatus 2 includes a cache control system 10, a non-transitory storage system 20, at least one processor 30, and a communication unit 40. The cache control system 10 includes a receiving module 100, a response module 200, and a estimation module 300. The modules 100˜300 are configured to be executed by one or more processors (for example the processor 30) to achieve functionality. The non-transitory storage system 20 can store code and data as to the cache control system 10 and store video data blocks obtained from the content source 6.

The receiving module 100 receives, from the client 4A, one or more requests for one or more first-resolution video data blocks (e.g., a 1-th request for the first-resolution 1-th video data block A₁).

The response module 200 generates a first pre-fetch process in response to the 1-th request, wherein the first pre-fetch process controls the cache apparatus 2 to pre-fetch the first-resolution 1-th video data block A₁ and subsequent video data blocks (e.g., A₂, A₃, A₄, . . . ) from the content source 6. In the embodiment, after receiving the 1-th request for A₁ from the client 4A, the response module 200 not only pre-fetches the A₁, but also pre-fetches the subsequent video data blocks (e.g., A₂, A₃, A₄, . . . ) if network conditions between the cache apparatus 2 and the content source 6 permits. Then, the response module 200 provides Aₗ to the client 4A, and provides A₂ to the client 4A when the receiving module 100 receives a 2-th request for A₂, provides A₃ to the client 4A when the receiving module 100 receives a 3-th request for A₃, and so on. When the receiving module 100 receives the 2-th request for A₂, the response module 200 prioritizes providing the client 4A with the A₂ pre-fetched and stored in the cache apparatus 2.

In the embodiment, when the receiving module 100 receives the 1-th request for the A₁, the response module 200 determines whether the A₁ is stored in the cache apparatus 2. If it is determined that the A₁ is stored in the cache apparatus 2, the response module 200 directly provides the client 4A with the A₁ stored in the cache apparatus 2. If it is determined that the A₁ is not stored in the cache apparatus 2, the response module 200 generates the first pre-fetch process to pre-fetch the A₁ from the content source 6 and then provides the A₁ to the client 4A.

If both the processor in client 4A and the first network between the client 4A and the cache apparatus 2 are operating below capacity, the client 4A may request a higher resolution of streaming media. For example, from a n-th video data block (including Aₙ, Bₙ, . . . ) of the “sample ” file, the client 4A begins to request a second-resolution n-th video data block Bₙ and subsequent video data blocks (e.g., Bₙ₊₁, B ₙ₊₂, Bₙ₊₃, . . . ).

The receiving module 100 receives, from the client 4A, an n-th request for the second-resolution n-th video data block B. In response to the n-th request for the Bₙ, the response module 200 determines whether pre-fetching the Bₙ from the content source 6 is supported according to quality of service (QoS) value of the second network between the cache apparatus 2 and the content source 6. In the embodiment, the QoS refers to available bandwidth of the second network between the cache apparatus 2 and the content source 6, to the system operating status of the cache apparatus 2 and of the content source 6, and to other factors.

If it is determined that pre-fetching the Bₙ from the content source 6 is not supported by the QoS of the second network, the response module 200 limits data transmission speed from the cache apparatus 2 to the client 4A and provides a first-resolution n-th video data block Aₙ to the client 4A. The limit on data transmission speed from the cache apparatus 2 to the client 4A is able to guide the client 4A to reduce expectation to request first-resolution subsequent video data blocks (e.g., Aₙ₊₁, Aₙ₊₂, . . . ). In one embodiment, the response module 200 limits on data transmission speed by port settings, bandwidth allocation, delay-feedback, or the like. The delay-feedback means reducing speed of the cache apparatus feeding back video data blocks to the client 4A (i.e., increasing interval time between which the cache apparatus feeds back video data blocks to the client 4A).

If it is determined that pre-fetching the Bₙ from the content source 6 is supported by the QoS of the second network, the response module 200 switches from the first pre-fetch process to a second pre-fetch process. The second pre-fetch process controls the cache apparatus 2 to pre-fetch the Bₙ and subsequent video data blocks (e.g., Bₙ₊₁, Bₙ₊₂, Bₙ₊₃, . . . ) of the Bₙ from the content source 6. Then, the response module 200 can provide the client 4A with the Bₙ which was pre-fetched by the second pre-fetch process.

In the embodiment, the receiving module 100 receives the n-th request for the Bₙ and the response module 200 determines whether the Bₙ is stored in the cache apparatus 2. If it is determined that the Bₙ is stored in the cache apparatus 2, the response module 200 directly provides the client 4A with the B.

The cache control system also includes the estimation module 300. The estimation module 300 is configured to determine QoS of the first network between the cache apparatus 2 and the client 4A and estimate a probability of the cache apparatus 2 receiving a m-th request from the client 4A for a second-resolution m-th video data block Bₘ. Such estimation of probability is based on a result of determination, the probability increasing with improvement of the network status of the first network. The probability so estimated is compared with a predefined threshold value. If the probability is larger than the predefined threshold value, a determination can be made that pre-fetching a Aₘ and the Bₘ from the content source 6 is supported, and the first pre-fetch process and the second pre-fetch process are operated in parallel. Thereby, the first pre-fetch process pre-fetches the Aₘ and subsequent video data blocks (e.g., Aₘ₊₁, Aₘ₊₂, Aₘ₊₃, . . . ), and the second pre-fetch process pre-fetches the Bₘ and subsequent video data blocks (e.g., Bₘ₊₁, Bₘ₊₂, Bₘ₊₃, . . . ) of the Bₘ.

When the receiving module 100 receives the m-th request for the Bₘ or subsequent requests for the subsequent video data blocks (e.g., Bₘ₊₁, Bₘ₊₂, Bₘ₊₃, . . . ), the response module 200 provides the client 4A with the Bₘ or the subsequent video data blocks (e.g., Bₘ₊₁, Bₘ₊₂, Bₘ₊₃, . . . ), and terminates the first pre-fetch process. The second pre-fetch process is continued. In other words, if the receiving module 100 still receives the m-th request for the Aₘ, the response module still provides the Aₘ to the client 4A, and both the first pre-fetch process and the second pre-fetch process are still operated in parallel. Then, if the receiving module 100 receives a subsequent request of the m-th request (e.g., the (m+1)-th request for the Bₘ₊₁), the response module provides the Bₘ₊₁ to the client 4A, and terminates the first pre-fetch process whilst continuing to operate the second pre-fetch process.

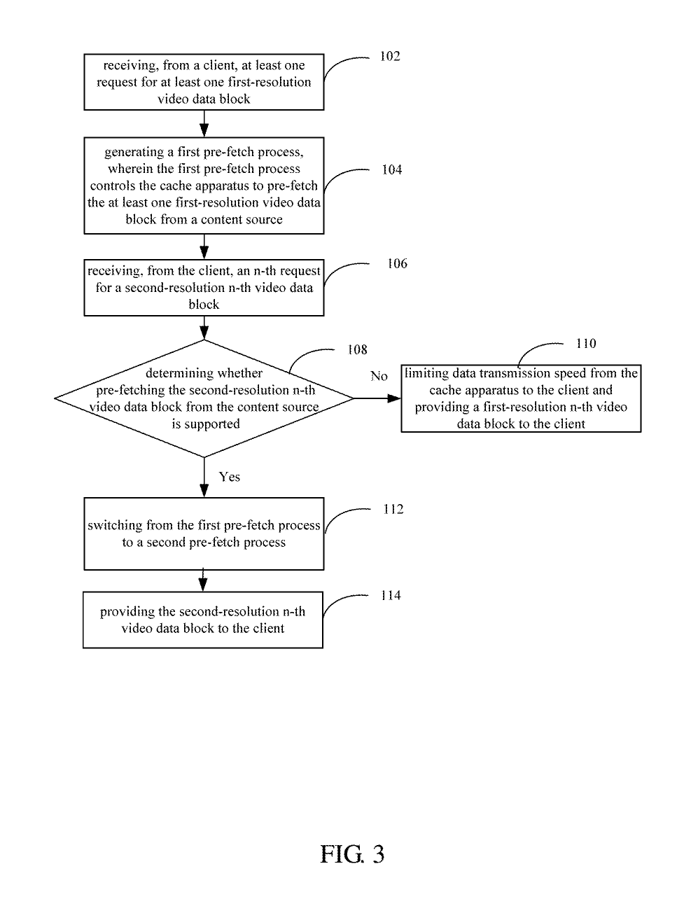

FIG. 3 illustrates a flowchart of embodiment of a method for optimizing streaming media transmission. The method is provided by way of example, as there are a variety of ways to carry out the method. The method described below can be carried out using the cache apparatus 2 illustrated in FIG. 2, for example, and various elements of these figures are referenced in explaining the processing method. The cache apparatus 2 is not to limit the operation of the method, which also can be carried out using other devices. Each step shown in FIG. 3 represents one or more processes, methods, or subroutines, carried out in the exemplary processing method. Additionally, the illustrated order of blocks is by example only and the order of the blocks can change. The method begins at block 102.

At block 102, the cache apparatus 2 receives, from the client 4A, one or more requests for one or more first-resolution video data blocks (e.g., a 1-th request for the A₁).

At block 104, the cache apparatus 2 generates a first pre-fetch process in response to the 1-th request, wherein the first pre-fetch process controls the cache apparatus 2 to the first-resolution 1-th video data block A₁ and subsequent video data blocks (e.g., A₂, A₃, A₄, . . . ) from the content source 6. Then, the cache apparatus 2 provides the A₁ to the client 4A, and provides the A₂ to the client 4A when the cache apparatus 2 receives a 2-th request for the A₂, provides the A₃ to the client 4A when the cache apparatus 2 receives a 3-th request for the A₃, and so on.

In the embodiment, at block 104, the cache apparatus 2 prioritizes determining whether the A₁ is stored in the cache apparatus 2. If it is determined that the A₁ is stored in the cache apparatus 2, the cache apparatus 2 directly provides the client 4A with the A₁ stored in the cache apparatus 2. If it is determined that the A₁ is not stored in the cache apparatus 2, the cache apparatus 2 generates the first pre-fetch process to pre-fetch the A₁ from the content source 6 and then provides the A₁ to the client 4A.

At block 106, the cache apparatus 2 receives, from the client 4A, an n-th request for a B.

In the embodiment, the cache apparatus 2 may give a priority to determine whether the Bₙ is stored in the cache apparatus 2. If it is determined that the Bₙ is stored in the cache apparatus 2, the cache apparatus 2 directly provides the Bₙ stored in the cache apparatus 2 to the client 4A. If not, the flowchart goes to block 108.

At block 108, the cache apparatus 2 determines whether pre-fetching the Bₙ from the content source 6 is supported according to QoS of the second network between the cache apparatus 2 and the content source 6. If yes, the flowchart goes to block 112. If no, the flowchart goes to block 110.

At block 110, the cache apparatus 2 limits data transmission speed from the cache apparatus 2 to the client 4A and provides a first-resolution n-th video data block Aₙ to the client 4A.

At block 112, the cache apparatus 2 switches from the first pre-fetch process to a second pre-fetch process, wherein the second pre-fetch process controls the cache apparatus 2 to pre-fetch the Bₙ and subsequent video data blocks (e.g., Bₙ₊₁, Bₙ₊₂, Bₙ₊₃, . . . ) from the content source 6.

At block 114, the cache apparatus 2 provides the client 4A with the Bₙ obtained from block 112; and waits to receive subsequent requests for the subsequent video data blocks (e.g., Bₙ₊₁, Bₙ₊₂, Bₙ₊₃, . . . ) to provide the client 4A with the subsequent video data blocks (e.g., Bₙ₊₁, Bₙ₊₂, Bₙ₊₃, . . . ).

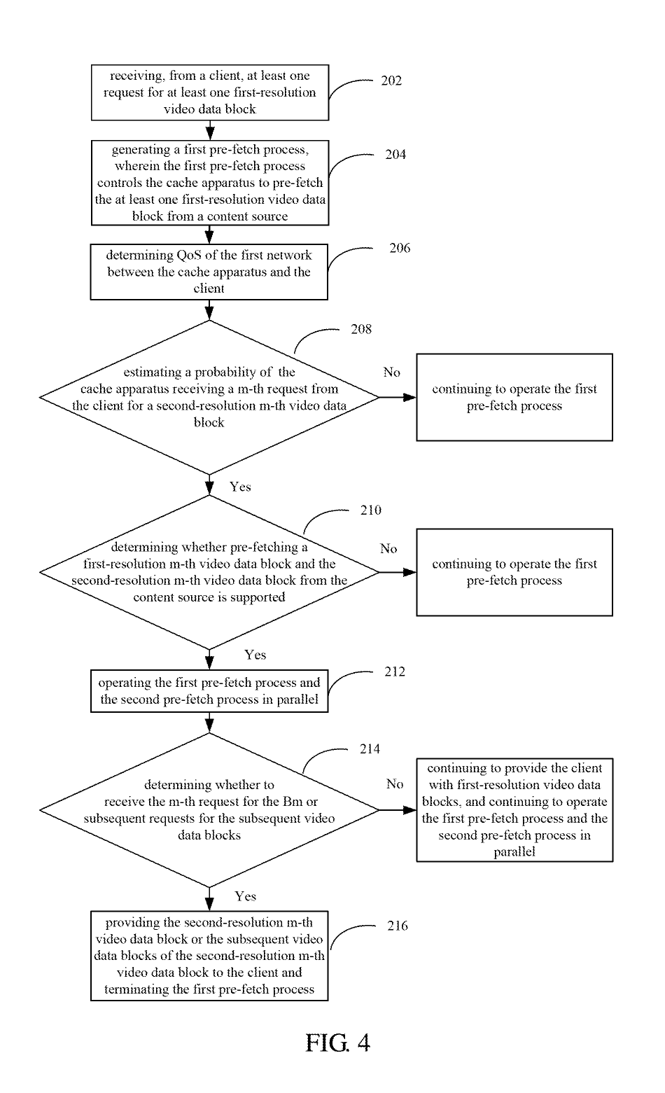

FIG. 4 illustrates a flowchart of another embodiment of a method for optimizing streaming media transmission. In the embodiment, the cache apparatus 2 is able to pre-fetch and store higher-resolution video data blocks before receiving requests for the higher-resolution video data blocks from a client (e.g., 4A). based on the similar method above, the cache apparatus 2 also adapts to be able to pre-fetch and store lower-resolution video data blocks before receiving requests for the lower-resolution video data blocks from a client (e.g., 4A). The method begins at block 202.

At block 202, the cache apparatus 2 receives, from the client 4A, one or more requests for one or more first-resolution video data blocks (e.g., a 1-th request for the A₁).

At block 204, the cache apparatus 2 generates a first pre-fetch process in response to the 1-th request, wherein the first pre-fetch process controls the cache apparatus 2 to the first-resolution 1-th video data block A₁ and subsequent video data blocks (e.g., A₂, A₃, A₄, . . . ) from the content source 6. Then, the cache apparatus 2 provides the A₁ to the client 4A, and provides the A₂ to the client 4A when t the cache apparatus 2 receives a 2-th request for A₂, provides the A₃ to the client 4A when the cache apparatus 2 receives a 3-th request for A₃, and so on.

At block 206, the cache apparatus 2 determines QoS value of the first network between the cache apparatus 2 and the client 4A.

At block 208, the cache apparatus 2 estimates a probability of the cache apparatus 2 receiving a m-th request from the client 4A for a second-resolution m-th video data block Bₘ. Such estimation of probability is based on a result of determination. The probability so estimated is compared with a predefined threshold value. If the probability is larger than the predefined threshold value, the flowchart goes to block 210. If no, the flowchart continues to operate the first pre-fetched process generated at the block 204.

At block 210, the cache apparatus 2 determines whether pre-fetching a Aₘ and the Bₘ in parallel from the content source 6 is supported. If yes, the flowchart goes to block 212. If no, the flowchart continues to operate the first pre-fetched process generated at the block 204.

At block 212, the cache apparatus 2 operates the first pre-fetch process and the second pre-fetch process in parallel, wherein the first pre-fetch process pre-fetches pre-fetching the Aₘ and subsequent video data blocks (e.g., Aₘ₊₁, Aₘ₊₂, Aₘ₊₃, . . . ), and the second pre-fetch process pre-fetches the Bₘ and subsequent video data blocks (e.g., Bₘ₊₁, Bₘ₊₂, Bₘ₊₃, . . . ) of the Bₘ.

At block 214, the cache apparatus 2 determines whether to receive the m-th request for the Bₘ or subsequent requests for the subsequent video data blocks (e.g., Bₘ₊₁, Bₘ₊₂, Bₘ₊₃, . . . ). If yes, the flowchart goes to block 216. If no, the cache apparatus 2 continues to provide the client 4A with corresponding first-resolution video data blocks (e.g., Aₘ, Aₘ₊₁, Aₘ₊₂, . . . ), and continues to operate the first pre-fetch process and the second pre-fetch process in parallel.

At block 216, the cache apparatus 2 provides the client 4A with the Bₘ or the subsequent video data blocks (e.g., Bₘ₊₁, Bₘ₊₂, Bₘ₊₃, . . . ), and terminates the first pre-fetch process and continue to operate the second pre-fetch process. The value m may equal to the value n.

It should be emphasized that the above-described embodiments of the present disclosure, including any particular embodiments, are merely possible examples of implementations, set fourth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A cache apparatus comprising:
a communication unit for connecting with a client via a first network and for connecting with a content source via a second network;
at least one processor;
a non-transitory storage system coupled to the at least one processor and configured to store one or more programs that are executed by the at least one processor, the one or more programs including instructions for:
receiving, from the client, at least one request for at least one first-resolution video data block;
in response to receiving the at least one request for the at least one first-resolution video data block: generating a first pre-fetch process, wherein the first pre-fetch process controls the cache apparatus to pre-fetch the at least one first-resolution video data block from the content source;
receiving, from the client, an n-th request for a second-resolution n-th video data block; and
in response to receiving the n-th request for the second-resolution n-th video data block:
determining whether pre-fetching the second-resolution n-th video data block from the content source is supported according to quality of service (QoS) of the second network between the cache apparatus and the content source; and
limiting data transmission speed from the cache apparatus to the client and providing a first-resolution n-th video data block to the client, when pre-fetching the second-resolution n-th video data block from the content source is not supported.

2. The cache apparatus as claimed in claim 1, further comprising:
when pre-fetching the second-resolution n-th video data block from the content source is supported, switching from the first pre-fetch process to a second pre-fetch process, wherein the second pre-fetch process controls the cache apparatus to pre-fetch the second-resolution n-th video data block and subsequent video data blocks of the second-resolution n-th video data block from the content source; and
providing the second-resolution n-th video data block to the client.

3. The cache apparatus as claimed in claim 1, further comprising:
determining QoS of the first network between the cache apparatus and the client;
estimating a probability of the cache apparatus receiving a m-th request from the client for a second-resolution m-th video data block, base on a result of determination;
comparing the probability with a predefined threshold value, and when the probability is larger than the predefined threshold value, determining that pre-fetching a first-resolution m-th video data block and the second-resolution m-th video data block from the content source is supported.
operating the first pre-fetch process and the second pre-fetch process in parallel, wherein the first pre-fetch process pre-fetches the first-resolution m-th video data block and subsequent video data blocks of the first-resolution m-th video data block, and the second pre-fetch process pre-fetches the second-resolution m-th video data block and subsequent video data blocks of the second-resolution m-th video data block; and
when the m-th request for the second-resolution m-th video data block or subsequent requests for the subsequent video data blocks of the second-resolution m-th video data block is received, providing the second-resolution m-th video data block or the subsequent video data blocks of the second-resolution m-th video data block to the client and terminating the first pre-fetch process.

4. The cache apparatus as claimed in claim 1, in response to receiving the at least one request for the at least one first-resolution video data block further comprising:
determining whether the at least one first-resolution video data block is stored in the cache apparatus; and
providing the at least one first-resolution video data block stored in the cache apparatus to the client, when the at least one first-resolution video data block is stored in the cache apparatus.

5. The cache apparatus as claimed in claim 1, in response to receiving the n-th request for the second-resolution n-th video data block, further comprising:
determining whether the second-resolution n-th video data block is stored in the cache apparatus; and
providing the second-resolution n-th video data block stored in the cache apparatus to the client, when the second-resolution n-th video data block is stored in the cache apparatus.

6. A method for optimizing streaming media transmission, executable by a processor of a cache apparatus, the method comprising:
receiving, from a client, at least one request for at least one first-resolution video data block;
in response to receiving the at least one request for the at least one first-resolution video data block: generating a first pre-fetch process, wherein the first pre-fetch process controls the cache apparatus to pre-fetch the at least one first-resolution video data block from a content source;
receiving, from the client, an n-th request for a second-resolution n-th video data block; and
in response to receiving the n-th request for the second-resolution n-th video data block:
determining whether pre-fetching the second-resolution n-th video data block from the content source is supported according to quality of service (QoS) of a second network between the cache apparatus and the content source; and
limiting data transmission speed from the cache apparatus to the client and providing a first-resolution n-th video data block to the client, when pre-fetching the second-resolution n-th video data block from the content source is not supported.

7. The method as claimed in claim 6, further comprising:
when pre-fetching the second-resolution n-th video data block from the content source is supported, switching from the first pre-fetch process to a second pre-fetch process, wherein the second pre-fetch process controls the cache apparatus to pre-fetch the second-resolution n-th video data block and subsequent video data blocks of the second-resolution n-th video data block from the content source; and
providing the second-resolution n-th video data block to the client.

8. The method as claimed in claim 6, further comprising:
determining QoS of the first network between the cache apparatus and the client;
estimating a probability of the cache apparatus receiving a m-th request from the client for a second-resolution m-th video data block, base on a result of determination;
comparing the probability with a predefined threshold value, and when the probability is larger than the predefined threshold value, determining that pre-fetching a first-resolution m-th video data block and the second-resolution m-th video data block from the content source is supported.
operating the first pre-fetch process and the second pre-fetch process in parallel, wherein the first pre-fetch process pre-fetches the first-resolution m-th video data block and subsequent video data blocks of the first-resolution m-th video data block, and the second pre-fetch process pre-fetches the second-resolution m-th video data block and subsequent video data blocks of the second-resolution m-th video data block; and
when the m-th request for the second-resolution m-th video data block or subsequent requests for the subsequent video data blocks of the second-resolution m-th video data block is received, providing the second-resolution m-th video data block or the subsequent video data blocks of the second-resolution m-th video data block to the client and terminating the first pre-fetch process.

9. The method as claimed in claim 6, in response to receiving the at least one request for the at least one first-resolution video data block, further comprising:
determining whether theat least one first-resolution video data block is stored in the cache apparatus; and
providing the at least one first-resolution video data block stored in the cache apparatus to the client, when the at least one first-resolution video data block is stored in the cache apparatus.

10. The method as claimed in claim 6, in response to receiving the n-th request for the second-resolution n-th video data block, further comprising:
determining whether the second-resolution n-th video data block is stored in the cache apparatus; and
providing the second-resolution n-th video data block stored in the cache apparatus to the client, when the second-resolution n-th video data block is stored in the cache apparatus.

11. A non-transitory computer readable storage medium configured to store a set of instructions, the set of instructions being executed by a processor of a cache apparatus, to perform a method comprising:
receiving, from a client, at least one request for at least one first-resolution video data block;
in response to receiving the at least one request for the at least one first-resolution video data block: generating a first pre-fetch process, wherein the first pre-fetch process controls the cache apparatus to pre-fetch the at least one first-resolution video data block from a content source;
receiving, from the client, an n-th request for a second-resolution n-th video data block; and
in response to receiving the n-th request for the second-resolution n-th video data block:
determining whether pre-fetching the second-resolution n-th video data block from the content source is supported according to quality of service (QoS) of a second network between the cache apparatus and the content source; and
limiting data transmission speed from the cache apparatus to the client and providing a first-resolution n-th video data block to the client, when pre-fetching the second-resolution n-th video data block from the content source is not supported.

12. The non-transitory computer readable storage medium as claimed in claim 11, in response to receiving the n-th request for the second-resolution n-th video data block, further comprises:
when pre-fetching the second-resolution n-th video data block from the content source is supported, switching from the first pre-fetch process to a second pre-fetch process, wherein the second pre-fetch process controls the cache apparatus to pre-fetch the second-resolution n-th video data block and subsequent video data blocks of the second-resolution n-th video data block from the content source; and
providing the second-resolution n-th video data block to the client.

13. The non-transitory computer readable storage medium as claimed in claim 11, the non-transitory computer readable storage medium further comprises:
determining QoS of the first network between the cache apparatus and the client;
estimating a probability of the cache apparatus receiving a m-th request from the client for a second-resolution m-th video data block, base on a result of determination;
comparing the probability with a predefined threshold value, and when the probability is larger than the predefined threshold value, determining that pre-fetching a first-resolution m-th video data block and the second-resolution m-th video data block from the content source is supported.
operating the first pre-fetch process and the second pre-fetch process in parallel, wherein the first pre-fetch process pre-fetches the first-resolution m-th video data block and subsequent video data blocks of the first-resolution m-th video data block, and the second pre-fetch process pre-fetches the second-resolution m-th video data block and subsequent video data blocks of the second-resolution m-th video data block; and
when the m-th request for the second-resolution m-th video data block or subsequent requests for the subsequent video data blocks of the second-resolution m-th video data block is received, providing the second-resolution m-th video data block or the subsequent video data blocks of the second-resolution m-th video data block to the client and terminating the first pre-fetch process.

14. The non-transitory computer readable storage medium as claimed in claim 11, in response to receiving the at least one request for the at least one first-resolution video data block, further comprising:
determining whether the at least one first-resolution video data block is stored in the cache apparatus; and
providing the at least one first-resolution video data block stored in the cache apparatus to the client, when the at least one first-resolution video data block is stored in the cache apparatus.

15. The non-transitory computer readable storage medium as claimed in claim 11, in response to receiving the n-th request for the second-resolution n-th video data block, further comprising:
determining whether the second-resolution n-th video data block is stored in the cache apparatus; and
providing the second-resolution n-th video data block stored in the cache apparatus to the client, when the second-resolution n-th video data block is stored in the cache apparatus.
